(19) United States
(12) Patent Application Publication
(10) Pub. No.: US 2025/0039832 A1
(43) Pub. Date: Jan. 30, 2025

(54) ENHANCEMENT ON SIDELINK POSITIONING

(71) Applicant: Nokia Technologies Oy, Espoo (FI)

(72) Inventor: Stepan KUCERA, Munich (DE)

(21) Appl. No.: 18/772,763

(22) Filed: Jul. 15, 2024

Related U.S. Application Data
(60) Provisional application No. 63/515,441, filed on Jul. 25, 2023.

(51) Int. Cl. H04W 64/00

(52) U.S. Cl. CPC H04W 64/00

(57) ABSTRACT

Embodiments of the present disclosure relate to apparatuses, methods, and computer readable storage media for monitoring performance of channel classification. A first apparatus transmits a discovery request for device discovery via sidelink communication. The first apparatus receives, from at least one candidate device, at least one respective discovery response comprising a location information status of a corresponding one of the at least one candidate device. The first apparatus transmits a candidate device list with the location information status to a second apparatus for localizing the first apparatus. In this way, both a target UE and a located UE with expired location can be efficiently localized without degradation in an achievable localization accuracy.

### CROSS-REFERENCE TO RELATED APPLICATION

The present application claims priority to, and the benefit of U.S. Provisional Application No. 63/515,441, filed Jul. 25, 2023, the contents of which are hereby incorporated by reference in their entirety.

### FIELDS

Various example embodiments of the present disclosure generally relate to the field of telecommunication and in particular, to methods, devices, apparatuses and computer readable storage medium for sidelink (SL) positioning.

### BACKGROUND

In SL positioning, a terminal device (e.g., UE) whose location is known and/or can be determined readily, e.g., by using Global Navigation Satellite System (GNSS), Uu-based techniques, may be used as an anchor for positioning purposes (e.g., absolute positioning). Such a terminal device is also called “located UE”. Other terminal devices to be localized may discover located UEs, and use location information of these located UEs for self-localization or location management function (LMF)-based positioning.

Due to some factors, such as, mobility, the role of located UE is dynamic and may change over time. Thus, the discovery result needs to be refreshed if there is a delay between the time when a located UE is discovered by the terminal device to be localized and the initiation of a ranging procedure with respect to the discovered located UE. In other words, the location of a located UE needs to be periodically updated to avoid location information expiry.

### SUMMARY

In a first aspect of the present disclosure, there is provided a first apparatus. The first apparatus comprises at least one processor; and at least one memory storing instructions that, when executed by the at least one processor, cause the first apparatus at least to: transmit a discovery request for device discovery via SL communication; receive, from at least one candidate device, at least one respective discovery response comprising a location information status of a corresponding one of the at least one candidate device; and transmit a candidate device list with the location information status to a second apparatus for localizing the first apparatus.

In a second aspect of the present disclosure, there is provided a second apparatus. The second apparatus comprises at least one processor; and at least one memory storing instructions that, when executed by the at least one processor, cause the second apparatus at least to: receive, from a first apparatus, a candidate device list comprising at least one candidate device with a respective location information status; determine, from the candidate device list, a plurality of terminal devices for localizing the first apparatus, at least one of the plurality of terminal devices being with invalid location information status; transmit, to the at least one terminal device with the invalid location information status, an indication of additional device discovery with reference information about an additional device to be discovered; receive, from the at least one terminal device with the invalid location information status, an additional device list comprising at least one additional device conforming the reference information; and localize, with an assistance of at least a part of the terminal devices with valid location information statuses and the at least one additional device, the first apparatus and the at least one terminal device with the invalid location information status.

In a third aspect of the present disclosure, there is provided a third apparatus. The third apparatus comprises at least one processor; and at least one memory storing instructions that, when executed by the at least one processor, cause the third apparatus at least to: receive, from a first apparatus, a discovery request for device discovery via SL communication; transmit, to the first apparatus, a discovery response comprising an invalid location information status of the third apparatus; upon receipt of an indication of additional device discovery from a second apparatus for location management, perform the additional device discovery, the indication comprising reference information about an additional device to be discovered; determine at least one additional device conforming the reference information; and transmit an additional device list comprising the at least one additional device to the second apparatus for localizing the first apparatus.

In a fourth aspect of the present disclosure, there is provided a fourth apparatus. The fourth apparatus comprises at least one processor; and at least one memory storing instructions that, when executed by the at least one processor, cause the fourth apparatus at least to: obtain at least one location information status of at least one candidate device via SL communication; determine, from the at least one candidate device, a plurality of terminal devices for localizing the fourth apparatus, at least one of the plurality of terminal devices being with invalid location information status; transmit, to the at least one terminal device with the invalid location information status, an indication of additional device discovery with reference information about an additional device to be discovered; receive, from the at least one terminal device with the invalid location information status, an additional device list comprising at least one additional device conforming the reference information; and localizing, with an assistance of at least a part of the terminal devices with valid location information statuses and the at least one additional device, the fourth apparatus.

In a fifth aspect of the present disclosure, there is provided a method. The method comprises: transmitting a discovery request for device discovery via SL communication; receiving, from at least one candidate device, at least one respective discovery response comprising a location information status of a corresponding one of the at least one candidate device; and transmitting a candidate device list with the location information status to a second apparatus for localizing the first apparatus.

In a sixth aspect of the present disclosure, there is provided a method. The method comprises: receiving, from a first apparatus, a candidate device list comprising at least one candidate device with a respective location information status; determining, from the candidate device list, a plurality of terminal devices for localizing the first apparatus, at least one of the plurality of terminal devices being with invalid location information status; transmitting, to the at least one terminal device with the invalid location information status, an indication of additional device discovery with reference information about an additional device to be discovered; receiving, from the at least one terminal device with the invalid location information status, an additional device list comprising at least one additional device conforming the reference information; and localizeing, with an assistance of at least a part of the terminal devices with valid location information statuses and the at least one additional device, the first apparatus and the at least one terminal device with the invalid location information status.

In a seventh aspect of the present disclosure, there is provided a method. The method comprises: receiving, from a first apparatus, a discovery request for device discovery via SL communication; transmitting, to the first apparatus, a discovery response comprising an invalid location information status of the third apparatus; upon receipt of an indication of additional device discovery from a second apparatus for location management, performing the additional device discovery, the indication comprising reference information about an additional device to be discovered; determining at least one additional device conforming the reference information; and transmitting an additional device list comprising the at least one additional device to the second apparatus for localizing the first apparatus.

In an eighth aspect of the present disclosure, there is provided a method. The method comprises: obtaining at least one location information status of at least one candidate device via SL communication; determining, from the at least one candidate device, a plurality of terminal devices for localizing the fourth apparatus, at least one of the plurality of terminal devices being with invalid location information status; transmitting, to the at least one terminal device with the invalid location information status, an indication of additional device discovery with reference information about an additional device to be discovered; receiving, from the at least one terminal device with the invalid location information status, an additional device list comprising at least one additional device conforming the reference information; and localizing, with an assistance of at least a part of the terminal devices with valid location information statuses and the at least one additional device, the fourth apparatus.

In a ninth aspect of the present disclosure, there is provided a first apparatus. The first apparatus comprises means for transmitting a discovery request for device discovery via SL communication; means for receiving, from at least one candidate device, at least one respective discovery response comprising a location information status of a corresponding one of the at least one candidate device; and means for transmitting a candidate device list with the location information status to a second apparatus for localizing the first apparatus.

In a tenth aspect of the present disclosure, there is provided a second apparatus. The second apparatus comprises means for receiving, from a first apparatus, a candidate device list comprising at least one candidate device with a respective location information status; means for determining, from the candidate device list, a plurality of terminal devices for localizing the first apparatus, at least one of the plurality of terminal devices being with invalid location information status; means for transmitting, to the at least one terminal device with the invalid location information status, an indication of additional device discovery with reference information about an additional device to be discovered; means for receiving, from the at least one terminal device with the invalid location information status, an additional device list comprising at least one additional device conforming the reference information; and means for localizeing, with an assistance of at least a part of the terminal devices with valid location information statuses and the at least one additional device, the first apparatus and the at least one terminal device with the invalid location information status.

In a eleventh aspect of the present disclosure, there is provided a third apparatus. The third apparatus comprises means for receiving, from a first apparatus, a discovery request for device discovery via SL communication; means for transmitting, to the first apparatus, a discovery response comprising an invalid location information status of the third apparatus; means for upon receipt of an indication of additional device discovery from a second apparatus for location management, performing the additional device discovery, the indication comprising reference information about an additional device to be discovered; means for determining at least one additional device conforming the reference information; and means for transmitting an additional device list comprising the at least one additional device to the second apparatus for localizing the first apparatus.

In a twelfth aspect of the present disclosure, there is provided a fourth apparatus. The fourth apparatus comprises means for obtaining at least one location information status of at least one candidate device via SL communication; means for determining, from the at least one candidate device, a plurality of terminal devices for localizing the fourth apparatus, at least one of the plurality of terminal devices being with invalid location information status; means for transmitting, to the at least one terminal device with the invalid location information status, an indication of additional device discovery with reference information about an additional device to be discovered; means for receiving, from the at least one terminal device with the invalid location information status, an additional device list comprising at least one additional device conforming the reference information; and localizing, with an assistance of at least a part of the terminal devices with valid location information statuses and the at least one additional device, the fourth apparatus.

In a thirteenth aspect of the present disclosure, there is provided a computer readable medium. The computer readable medium comprises instructions stored thereon for causing an apparatus to perform at least the method according to the fifth aspect.

In a fourteenth aspect of the present disclosure, there is provided a computer readable medium. The computer readable medium comprises instructions stored thereon for causing an apparatus to perform at least the method according to the sixth aspect.

In a fifteenth aspect of the present disclosure, there is provided a computer readable medium. The computer readable medium comprises instructions stored thereon for causing an apparatus to perform at least the method according to the seventh aspect.

In a sixteenth aspect of the present disclosure, there is provided a computer readable medium. The computer readable medium comprises instructions stored thereon for causing an apparatus to perform at least the method according to the eighth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for SL positioning process according to some example embodiments of the present disclosure;

FIG. 3 illustrates an example communication environment in which example embodiments of the present disclosure can be implemented;

FIG. 4 illustrates a signaling chart for SL positioning according to some example embodiments of the present disclosure;

FIG. 5 illustrates a flowchart of a method implemented at a first apparatus according to some example embodiments of the present disclosure;

FIG. 6 illustrates a flowchart of a method implemented at a second apparatus according to some example embodiments of the present disclosure;

FIG. 7 illustrates a flowchart of a method implemented at a third apparatus according to some example embodiments of the present disclosure;

FIG. 8 illustrates a flowchart of a method implemented at a fourth apparatus according to some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “target UE” may refer to a UE to be localized. The term “located UE” may refer to a UE may be used as an anchor for positioning purpose. The location of located UE is known and/or can be determined readily, e.g., by using GNSS/Uu-based techniques.

In a communication system, a terminal device to be localized may be called “target UE”. The target UE can be localized if the locations of the anchor UEs (e.g., located UEs) are known. However, in a case that the location of one or more located UE expires, for example, due to the located UE's mobility, there is a need to update location information for the located UE.

In an existing positioning approach, a group of located UE may be discovered by the target UE. The located UE whose location is valid may be reused, and the located UE whose location is expired may be first localized. After all the located UE in the group are updated with valid location information, it proceeds with localizing the target UE by using the group of located UEs.

However, assuming that there is a total of N located UEs in the group where “X” located UEs whose location information is expired, the above existing approach theoretically corresponds to localizing the target UE with only N-X located UEs as the X located UEs do not contribute to the multi-lateration of the target UE.

To improve the efficiency and accuracy of SL positioning, the present disclosure provides a solution for localizing both the target UE and the located UEs with expired location. This solution is not only suitable for scenarios with network coverage, for example, by means of LMF, but also for scenarios out of network coverage. In some cases, such a localization can be realized in a single session without degradation in an achievable localization accuracy.

Example embodiments of the present disclosure will be described in detail below with reference to the accompanying drawings.

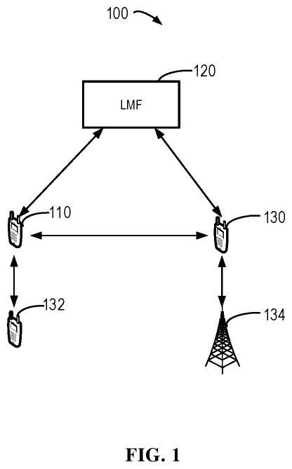

FIG. 1 illustrates an example communication environment 100 in which example embodiments of the present disclosure can be implemented. The communication environment 100 may support SL communications among terminal devices. As shown in FIG. 1, the communication environment 100 may comprise a first apparatus 110, a second apparatus 120, a third apparatus 130, a candidate device 132 and an additional device 134.

The first apparatus 110, the third apparatus 130, the candidate device 132 the additional device 134 may be terminal devices, such as, UE, and may communicate with each other via SL communication. In the example of FIG. 1, the first apparatus 110 may be a target UE to be localized, the third apparatus 130, the candidate device 132 and the additional device 134 may be the located UE for localizing the target UE, which will be discussed in detail below.

The second apparatus 120 may be a network device that implements an LMF (which is also referred to as LMF 120 hereinafter). The LMF may be a network entity located in core network (CN) or radio access network (RAN), which manages an overall coordination and scheduling of the resources required for positioning terminal devices registered to or accessing 5GCN. The LMF may calculate or verify a position and/or speed estimates of a UE. The LMF may receive a request for positioning a target UE from other network elements, such as, a gNB, an access and mobility management Function (AMF), and so on. The LMF may then interact with the target UE to exchange location information applicable to UE-assisted and UE-based positioning methods, and then return a location report.

In some example embodiments, the first apparatus 110 may be localized via an LMF-based positioning procedure or a UE-based positioning procedure. In particular, the LMF-based positioning procedure is initiated by the second apparatus 120 with a network coverage, while the UE-based positioning procedure is initiated by a server UE and may be performed out of the network coverage.

During either the LMF-based positioning procedure or the UE-based positioning procedure, the first apparatus 110 may discover a plurality of located UEs through UE discovery via SL communication. The discovered located UEs may report their location information status (LIS) to the first apparatus 110.

In some example embodiments, the LIS may be carried in, for example, a SL positioning protocol (SLPP) message by using a LIS flag “locValid”, where a first value of the LIS flag, e.g., locValid=1 indicates the location information of a corresponding UE is valid, and a second value of the LIS flag, e.g., locValid=0 indicates the location information of a corresponding UE is invalid or expired. The LIS may be used for performing a secondary discovery of additional devices for localizing the target UE, which will be discussed in detail below.

In the following, for the purpose of illustration, some example embodiments are described with the first apparatus 110, the third apparatus 130, the candidate device 132, and the additional device 134 operating as terminal devices and the second apparatus 120 operating as a network device. However, in some example embodiments, operations described in connection with a terminal device may be implemented at a network device or other device, and operations described in connection with a network device may be implemented at a terminal device or other device.

It is to be understood that the number of apparatuses and their connections shown in FIG. 1 are only for the purpose of illustration without suggesting any limitation. The communication network 100 may include any suitable number of apparatuses configured to implementing example embodiments of the present disclosure. Although not shown, it would be appreciated that one or more additional apparatuses and connections may be deployed in the communication network 100.

In some example embodiments, if the first apparatus 110 is a terminal device and the second apparatus 120 is a network device, a link from the second apparatus 120 to the first apparatus 110 is referred to as a downlink (DL), and a link from the first apparatus 110 to the second apparatus 120 is referred to as an uplink (UL). In DL, the second apparatus 120 is a transmitting (TX) device (or a transmitter) and the first apparatus 110 is a receiving (RX) device (or a receiver). In UL, the first apparatus 110 is a TX device (or a transmitter) and the second apparatus 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

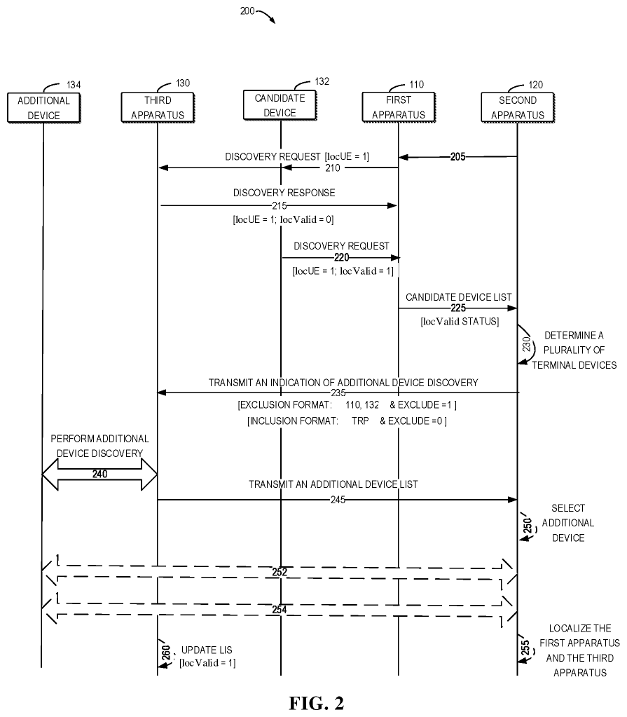

Reference is now made to FIG. 2, which illustrates a signaling chart for SL positioning process 200 according to some example embodiments of the present disclosure. As shown in FIG. 2, the process 200 involves at least the first apparatus 110, the second apparatus 120, the third apparatus 130, the candidate device 132 and the additional device 134. For the purpose of discussion, reference is made to FIG. 1 to describe the signaling flow 200.

The process 200 may be an LMF-based positioning procedure, and in the process 200, the first apparatus 110 acts as the target UE to be localized. The process 200 is initiated (205) by the second apparatus 120. To this end, the second apparatus 120 may transmit a mobile terminated localization request (MT-LR) to the first apparatus 110 for triggering a positioning session. However, in some cases, the process 200 may be based on a session-less positioning. Thus, the present disclosure is not limited in this regard.

The first apparatus 110 transmits (210, 215) a discovery request for device discovery via SL communication. For example, the discovery request may comprise a flag “locUE=1” for discovering located UEs or anchors.

Accordingly, the first apparatus 110 receives (220) at least one discovery response from at least one candidate device (e.g., located UEs). The discovery response may comprise a LIS of a corresponding candidate device. In other words, the discovered located UEs may report their respective LIS in the discovery response.

For example, the LIS may be carried in a SLPP message, either as a part of the SLPP metafield of the discovery message, or a stand-alone SLPP message for session control purpose. In particular, the LIS may by indicated by a LIS flag “locValid”. In some example embodiments, a first value of the LIS flag, e.g., locValid=1 indicates the location information of a corresponding UE is valid, and a second value of the LIS flag, e.g., locValid=0 indicates the location information of a corresponding UE is invalid or expired

In the example of FIG. 2, the at least one candidate device discovered by the first apparatus 110 comprises the third apparatus 130 and candidate device 132, where the LIS of the third apparatus 130 is invalid (i.e., locValid=0), for example, due to mobility from time of last position update, and the LIS of the candidate device 132 is still valid (i.e., locValid=1).

In this case, the target UE may report the located UE list to the LMF. As shown in FIG. 2, the first apparatus 110 transmits (225) a candidate device list with the LIS to the second apparatus 120 for localizing the first apparatus 110.

The second apparatus 120 determines (230), from the candidate device list, a plurality of terminal devices for localizing the first apparatus 110. In this example, at least one of the plurality of terminal devices is with invalid LIS. For example, the second apparatus 120 may confirm both the third apparatus 130 and candidate device 132 as anchors or located UEs of the first apparatus 110. Subsequently, the LMF may start positioning for the target UE.

The second apparatus 120 transmits (235), to the at least one terminal device with the invalid LIS, an indication of additional device discovery with reference information about an additional device to be discovered. The additional device discovery may be a secondary discovery of additional located UEs.

The reference information may comprise at least one of the following:
a first indicator of a device to be excluded from the additional device to be discovered, for example, pre-existing located UEs, such as, session members, i.e., “exclusion format=“110, 132” & “exclude=1”;
a second indicator of a device to be included as the additional device to be discovered. i.e., “inclusion format=“TRP” & “exclude=0”.

In the example of FIG. 2, the third apparatus 130 is requested to perform the secondary discovery of additional located UEs. To this end, the second apparatus 120 may indicate (e.g., as a part of assistance data) that both the target UE “110” (i.e., the first apparatus 110) and located UE “132” (i.e., the candidate device 132) shall be excluded from any consideration, for example, by setting LIS flag “exclude=1”. Alternatively, or additionally, the second apparatus 120 may positively indicate a network node to be discovered, such as, a nearby TRP by setting LIS flag “exclude=0”. The additional device may be either a terminal device or a network device.

Through the secondary discovery, the third apparatus 130 may determine (240) at least one additional device conforming the reference information, e.g., the additional device 132. The third apparatus 130 transmits (245) an additional device list comprising the at least one additional device (e.g., the additional device 134) to the second apparatus 120 for localizing the first apparatus 110.

In the example of FIG. 2, the additional device 134 (e.g., the nearby TRP) is selected (250) as additional located UE that can be used for localizing both the target UE and the located UE with invalid LIS.

The second apparatus 120 may then collect (252) assistant data from the located UEs. Additionally, the second apparatus 120 may receive (254) reference signal measurement reports from the located UEs, for example, based on SL positioning reference signals (PRSs).

With the assistance of at least a part of the terminal devices with valid LIS and the at least one additional device, the second apparatus 120 localizes (255), the first apparatus 110 and the at least one terminal device with the invalid LIS. In this example, the first apparatus 110 and the third apparatus 130 are jointly localized by using an increased number of anchors (i.e., UEs and/or TRP), thus the efficiency and accuracy of the SL positioning are improved.

After localizing the first apparatus 110 and the at least one terminal device with the invalid LIS, the second apparatus 120 may update the LIS of the at least one terminal device from invalid to valid.

The third apparatus 130 may then update (260) the LIS to be valid. For example, the LIS flag “locValid=0” of the third apparatus 130 may be updated to “locValid=1”. In some example embodiments, the updating of the LIS may be indicated by the LMF. In this case, the third apparatus 130 may receive an indication of updating the LIS from invalid to be valid from the second apparatus 120.

Alternatively, in some other embodiments, the third apparatus 130 may perform self-localization and determines its location based on a plurality of SL PRSs during the SL positioning. The third apparatus 130 may then update the LIS from invalid to valid.

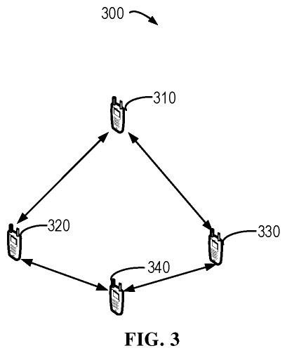

FIG. 3 illustrates an example communication environment 300 in which example embodiments of the present disclosure can be implemented. The communication environment 300 may support SL communications among terminal devices. As shown in FIG. 3, the communication environment 300 may comprise a fourth apparatus 310, candidate devices 320 and 330, and an additional device 340.

The communication environment 300 is similar to the communication environment 100 shown in FIG. 1, except for the absence of LMF, this may be due to being out of the network coverage.

The fourth apparatus 310, the candidate devices 320 and 330, and the additional device 340 may be terminal devices, such as, UE, and may communicate with each other via SL communication. In the example of FIG. 3, the fourth apparatus 310 may be a target UE to be localized, the candidate devices 320 and 330, and the additional device 340 may be terminal devices may be the located UE for localizing the target UE. In some cases, the fourth apparatus 310 may act as its own server UE.

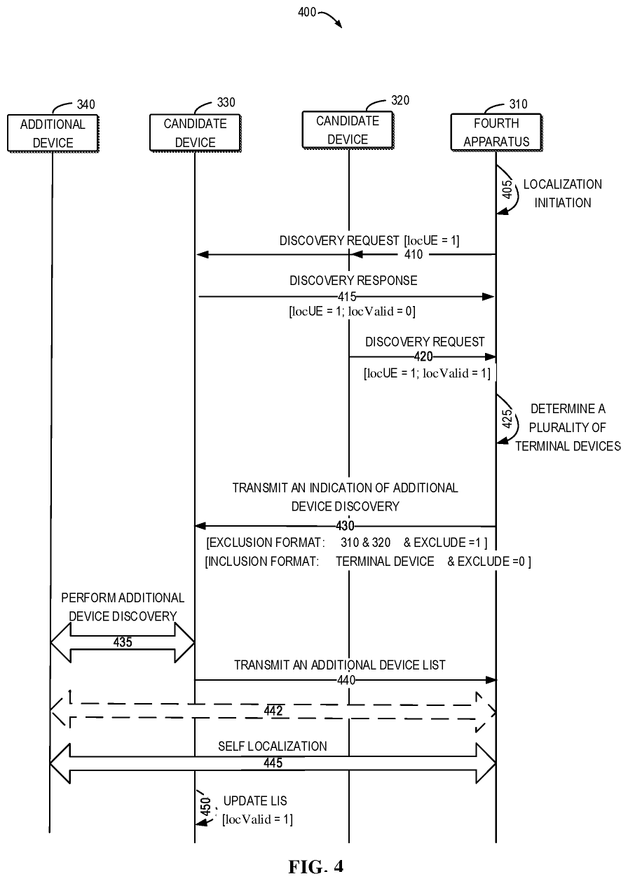

Reference is now made to FIG. 4, which illustrates a signaling chart for SL positioning process 400 according to some example embodiments of the present disclosure. As shown in FIG. 4, the process 400 involves at least the fourth apparatus 310, the candidate devices 320 and 330, and the additional device 340. For the purpose of discussion, reference is made to FIG. 3 to describe the signaling flow 400.

The process 400 may be a UE-based positioning procedure, which permits the target UE to discover and select anchors for itself. In the process 400, the fourth apparatus 110 acts as the target UE to be localized. Hence, the process 400 may be initiated (405) by a mobile oriented localization request (MO-LR). Additionally, in the example of FIG. 4, the fourth apparatus 110 is assumed to act as its own server UE.

After the process 400 is initiated, the fourth apparatus 310 obtains at least one LIS of at least one candidate device via SL communication, which may be similar to the process 200. For example, the fourth apparatus 310 may transmit (410, 415) a discovery request for device discovery via SL communication. The discovery request may comprise a flag “locUE=1” for discovering located UEs or anchors.

Accordingly, the fourth apparatus 110 receives (420) at least one discovery response from at least one candidate device (e.g., located UEs). The discovery response may comprise a LIS of a corresponding candidate device.

In the example of FIG. 4, the at least one candidate device discovered by the fourth apparatus 310 comprises the candidate devices 320 and 330, where the LIS of the candidate device 320 is still valid (i.e., locValid=1), while the LIS of the candidate device 330 is invalid (i.e., locValid=0).

The fourth apparatus 310 determines (425), from the at least one candidate device, a plurality of terminal devices for localizing the fourth apparatus 310. In this example, at least one of the plurality of terminal devices is with invalid LIS. A complementary search of anchors or located UEs independent from known UEs (e.g., the target UE, the pre-existing located UEs) may be needed.

The fourth apparatus 310 transmits (430), to the at least one terminal device with the invalid LIS (e.g., the candidate device 330), an indication of additional device discovery with reference information about an additional device to be discovered.

The reference information may comprise at least one of the following:
a first indicator of a device to be excluded from the additional device to be discovered, for example, pre-existing located UEs, such as, session members, i.e., “exclusion format=“310, 320” & “exclude=1”;
a second indicator of a device to be included as the additional device to be discovered. i.e., “inclusion format=“terminal device” & “exclude=0”.

As a result, the candidate device 330 is requested to perform the secondary discovery of additional located UEs. To this end, the fourth apparatus 310 may indicate (e.g., as a part of assistance data) that both the target UE “310” (i.e., the fourth apparatus 310) and located UE “320” (i.e., the candidate device 320) shall be excluded from any consideration, for example, by setting LIS flag “exclude=1”. Alternatively, or additionally, the fourth apparatus 310 may positively indicate a node to be discovered, such as, a terminal device by setting LIS flag “exclude=0”. The additional device may be either a terminal device or a network device.

Through the secondary discovery, the candidate device 320 determines (435) at least one additional device conforming the reference information, e.g., the additional device 340. The candidate device 320 the transmits (440) an additional device list comprising the at least one additional device (e.g., the additional device 340) to the fourth apparatus 310 for localizing the fourth apparatus 310. This results in an addition of the additional device 340 to the anchor set.

In some example embodiments, the fourth apparatus 310 may perform (442) SL PRS transmission with at least a part of the located UEs comprising the candidate devices 320 and 330 and the additional device 340, and localize (445) itself based on the SL PRSs. Additionally, the fourth apparatus 310 may also determine the location of the candidate device 330. In a case that the fourth apparatus 310 acts as a server UE, it may determine the locations based on observed time difference of arrival (OTDOA), round-trip time (RTT) associated with the plurality of SL PRSs, and so on.

Accordingly, the candidate device 330 may then update (450) the LIS to be valid. For example, the LIS flag “locValid=0” of the candidate device 330 may be updated to “locValid=1”.

In some example embodiments, the additional device 340 may optionally self-localize itself, for example, by using GNSS, in case its own location is unknown or expired meanwhile, and report the location information to the target UE or server UE (i.e., the fourth apparatus 310 in this example) who then localizes itself by using all the located UE, including the additional device 340.

Additionally, or alternatively, in some other embodiments, the location of additional device 340 may be valid. In this case, the target UE (i.e., the fourth apparatus 310 in this example) may simply localize itself by using the additional device 340 as its located UE.

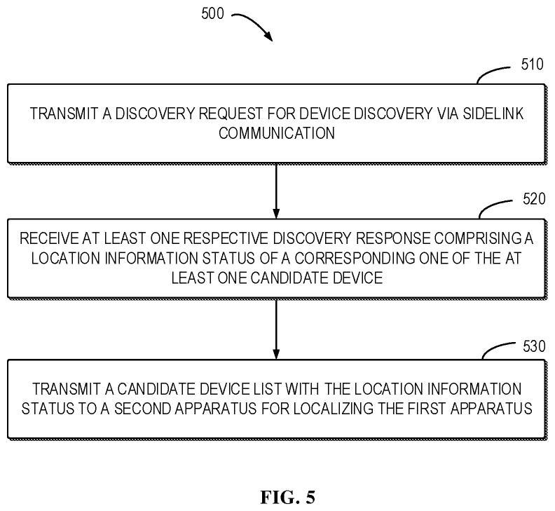

FIG. 5 shows a flowchart of an example method 500 implemented at a first device in accordance with some example embodiments of the present disclosure. For the purpose of discussion, the method 500 will be described from the perspective of the first apparatus 110 in FIG. 1.

At block 510, the first apparatus 110 transmits a discovery request for device discovery via SL communication.

At block 520, the first apparatus 110 receives, from at least one candidate device, at least one respective discovery response comprising a location information status of a corresponding one of the at least one candidate device.

At block 530, the first apparatus 110 transmits a candidate device list with the location information status to a second apparatus 120 for localizing the first apparatus 110.

In some example embodiments, the location information status may be indicated by an indicator. A first value of the indicator indicates the location information status of the corresponding candidate device is valid, and a second different value of the indicator indicates the location information status of the corresponding candidate device is invalid.

In some example embodiments, the localizing may be initiated by the second apparatus 120, and the second apparatus 120 may comprise a network device implementing LMF.

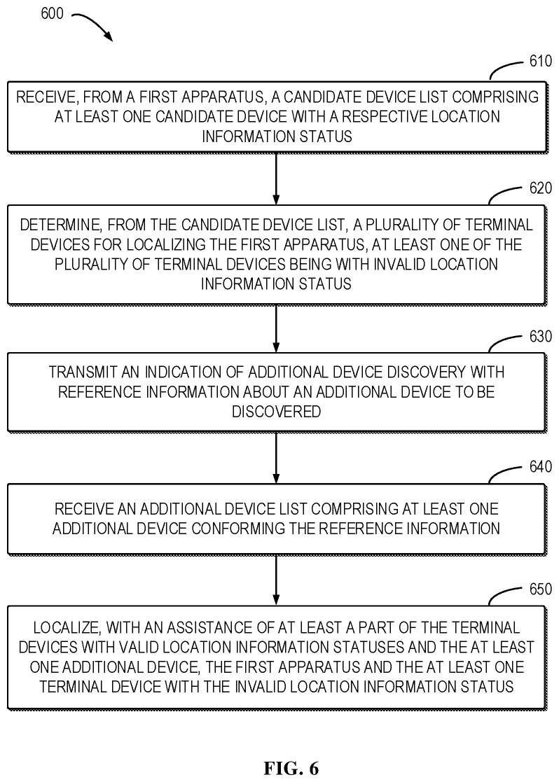

FIG. 6 shows a flowchart of an example method 600 implemented at a second device in accordance with some example embodiments of the present disclosure. For the purpose of discussion, the method 600 will be described from the perspective of the second apparatus 120 in FIG. 1.

At block 610, the second apparatus 120 receives, from a first apparatus 110, a candidate device list comprising at least one candidate device with a respective location information status.

At block 620, the second apparatus 120 determines, from the candidate device list, a plurality of terminal devices for localizing the first apparatus 110, at least one of the plurality of terminal devices being with invalid location information status.

At block 630, the second apparatus 120 transmits, to the at least one terminal device with the invalid location information status, an indication of additional device discovery with reference information about an additional device to be discovered.

At block 640, the second apparatus 120 receives, from the at least one terminal device with the invalid location information status, an additional device list comprising at least one additional device conforming the reference information.

At block 650, the second apparatus 120 localizes, with an assistance of at least a part of the terminal devices with valid location information statuses and the at least one additional device, the first apparatus 110 and the at least one terminal device with the invalid location information status.

In some example embodiments, the location information status may be indicated by an indicator, a first value of the indicator indicates the location information status of the corresponding candidate device is valid, and a second different value of the indicator indicates the location information status of the corresponding candidate device is invalid.

In some example embodiments, the localizing may be initiated by the second apparatus 120, and the second apparatus 120 may comprise a network device implementing LMF.

In some example embodiments, the reference information about the additional device to be discovered may comprise at least one of the following: a first indicator of a device to be excluded from the additional device to be discovered, or a second indicator of a device to be included as the additional device to be discovered.

In some example embodiments, the device to be excluded from the at least one additional device may comprise the first apparatus 110 and the terminal devices.

In some example embodiments, the at least one additional device may comprise at least one network device or at least one terminal device with valid location status.

In some example embodiments, the method 600 further comprises: after localizing the first apparatus 110 and the at least one terminal device with the invalid location information status, updating the location information status of the at least one terminal device from invalid to valid.

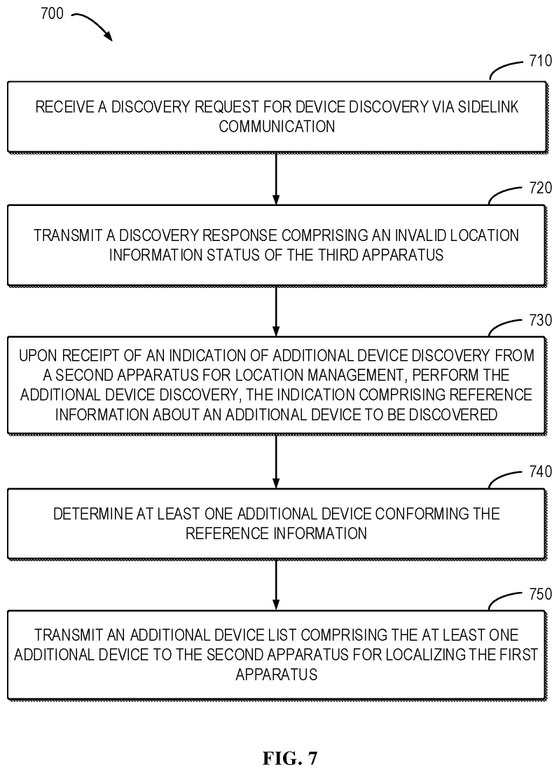

FIG. 7 shows a flowchart of an example method 700 implemented at a third device in accordance with some example embodiments of the present disclosure. For the purpose of discussion, the method 700 will be described from the perspective of the third apparatus 130 in FIG. 1.

At block 710, the third apparatus 130 receives, from a first apparatus 110, a discovery request for device discovery via SL communication.

At block 720, the third apparatus 130 transmits, to the first apparatus 110, a discovery response comprising an invalid location information status of the third apparatus 130.

At block 730, upon receipt of an indication of additional device discovery from a second apparatus 120 for location management, the third apparatus 130 performs the additional device discovery, the indication comprising reference information about an additional device to be discovered.

At block 740, the third apparatus 130 determines at least one additional device conforming the reference information.

At block 750, the third apparatus 130 transmits an additional device list comprising the at least one additional device to the second apparatus 120 for localizing the first apparatus 110.

In some example embodiments, the location information status may be indicated by an indicator. A first value of the indicator indicates the location information status is valid, and a second different value of the indicator indicates the location information status is invalid.

In some example embodiments, the reference information about the additional device to be discovered may comprise at least one of the following: a first indicator of a device to be excluded from the additional device to be discovered, or a second indicator of a device to be included as the additional device to be discovered.

In some example embodiments, the method 700 further comprises: receiving, from the second apparatus 120, an indication of updating the location information status to be valid.

In some example embodiments, the method 700 further comprises: determining, based on a plurality of SL positioning reference signals during the SL positioning, a location of the third apparatus 130; and updating the location information status of the third apparatus 130 from invalid to valid.

In some example embodiments, the at least one additional device may comprise at least one network device or at least one terminal device with valid location status.

In some example embodiments, the first apparatus 110 may be a first terminal device, the second apparatus 120 may be a network device implementing LMF, and the third apparatus 130 is a second terminal device.

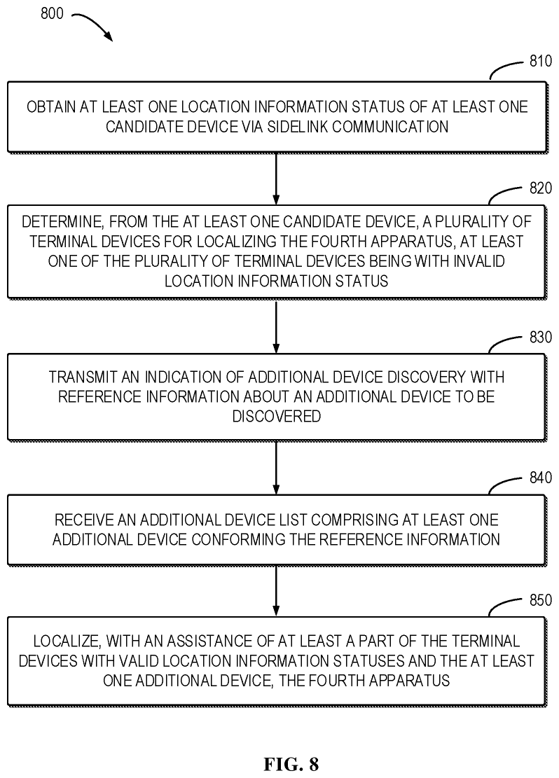

FIG. 8 shows a flowchart of an example method 800 implemented at a fourth device in accordance with some example embodiments of the present disclosure. For the purpose of discussion, the method 800 will be described from the perspective of the fourth apparatus 310 in FIG. 4.

At block 810, the fourth apparatus 310 obtains at least one location information status of at least one candidate device via SL communication.

At block 820, the fourth apparatus 310 determines, from the at least one candidate device, a plurality of terminal devices for localizing the fourth apparatus 310, at least one of the plurality of terminal devices being with invalid location information status.

At block 830, the fourth apparatus 310 transmits, to the at least one terminal device with the invalid location information status, an indication of additional device discovery with reference information about an additional device to be discovered.

At block 840, the fourth apparatus 310 receives, from the at least one terminal device with the invalid location information status, an additional device list comprising at least one additional device conforming the reference information; and localizing, with an assistance of at least a part of the terminal devices with valid location information statuses and the at least one additional device, the fourth apparatus 310.

In some example embodiments, the location information status may be indicated by an indicator. A first value of the indicator indicates the location information status of the corresponding candidate device is valid, and a second different value of the indicator indicates the location information status of the corresponding candidate device is invalid.

In some example embodiments, the localizing may be initiated by the fourth apparatus 310, and the fourth apparatus 310 may comprise a terminal device.

In some example embodiments, the reference information about the additional device to be discovered may comprise at least one of the following: a first indicator of a device to be excluded from the additional device to be discovered, or a second indicator of a device to be included as the additional device to be discovered.

In some example embodiments, the device to be excluded from the at least one additional device may comprise the fourth apparatus 310 and the plurality of terminal devices.

In some example embodiments, the method 800 further comprises: determining, based on a plurality of SL positioning reference signals during the SL positioning, a location of the fourth apparatus 310 and a location of the at least one terminal device.

In some example embodiments, the location of the fourth apparatus 310 and the location of the at least one terminal device may be determined based on observed time difference of arrival or round-trip time associated with the plurality of SL positioning reference signals.

In some example embodiments, the method 800 further comprises: transmitting, to the at least one terminal device with the invalid location information status, an indication of updating the location information status to be valid.

In some example embodiments, a first apparatus capable of performing any of the method 500 (for example, the first apparatus 110 in FIG. 1) may comprise means for performing the respective operations of the method 500. The means may be implemented in any suitable form. For example, the means may be implemented in a circuitry or software module. The first apparatus may be implemented as or included in the first device 110 in FIG. 1.

In some example embodiments, the first apparatus comprises means for transmitting a discovery request for device discovery via sidelink communication; means for receiving, from at least one candidate device, at least one respective discovery response comprising a location information status of a corresponding one of the at least one candidate device; and means for transmitting a candidate device list with the location information status to a second apparatus for localizing the first apparatus.

In some example embodiments, the location information status is indicated by an indicator, a first value of the indicator indicates the location information status of the corresponding candidate device is valid, and a second different value of the indicator indicates the location information status of the corresponding candidate device is invalid.

In some example embodiments, the localizing is initiated by the second apparatus, and the second apparatus comprises a network device implementing location management function.

In some example embodiments, the first apparatus further comprises means for performing other operations in some example embodiments of the method 500 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 600 (for example, the second apparatus 120 in FIG. 1) may comprise means for performing the respective operations of the method 600. The means may be implemented in any suitable form. For example, the means may be implemented in a circuitry or software module. The second apparatus may be implemented as or included in the second device 120 in FIG. 1.

In some example embodiments, the second apparatus comprises means for receiving, from a first apparatus, a candidate device list comprising at least one candidate device with a respective location information status; means for determining, from the candidate device list, a plurality of terminal devices for localizing the first apparatus, at least one of the plurality of terminal devices being with invalid location information status; means for transmitting, to the at least one terminal device with the invalid location information status, an indication of additional device discovery with reference information about an additional device to be discovered; means for receiving, from the at least one terminal device with the invalid location information status, an additional device list comprising at least one additional device conforming the reference information; and means for localizing, with an assistance of at least a part of the terminal devices with valid location information statuses and the at least one additional device, the first apparatus and the at least one terminal device with the invalid location information status.

In some example embodiments, the location information status is indicated by an indicator, a first value of the indicator indicates the location information status of the corresponding candidate device is valid, and a second different value of the indicator indicates the location information status of the corresponding candidate device is invalid.

In some example embodiments, the localizing is initiated by the second apparatus, and the second apparatus comprises a network device implementing a location management function.

In some example embodiments, the reference information about the additional device to be discovered comprises at least one of the following: a first indicator of a device to be excluded from the additional device to be discovered, or a second indicator of a device to be included as the additional device to be discovered.

In some example embodiments, the device to be excluded from the at least one additional device comprises the first apparatus and the terminal devices.

In some example embodiments, the at least one additional device comprises at least one network device or at least one terminal device with valid location status.

In some example embodiments, the second apparatus further comprises: means for after localizing the first apparatus and the at least one terminal device with the invalid location information status, updating the location information status of the at least one terminal device from invalid to valid.

In some example embodiments, the second apparatus further comprises means for performing other operations in some example embodiments of the method 600 or the second apparatus 120. In some example embodiments, the means comprises at least one processor; and at least one memory storing instructions that, when executed by the at least one processor, cause the performance of the second apparatus.

In some example embodiments, a third apparatus capable of performing any of the method 700 (for example, the third apparatus 130 in FIG. 1) may comprise means for performing the respective operations of the method 700. The means may be implemented in any suitable form. For example, the means may be implemented in a circuitry or software module. The third apparatus may be implemented as or included in the third apparatus 130 in FIG. 1.

In some example embodiments, the third apparatus comprises means for receiving, from a first apparatus, a discovery request for device discovery via sidelink communication; means for transmitting, to the first apparatus, a discovery response comprising an invalid location information status of the third apparatus; means for upon receipt of an indication of additional device discovery from a second apparatus for location management, performing the additional device discovery, the indication comprising reference information about an additional device to be discovered; means for determining at least one additional device conforming the reference information; and means for transmitting an additional device list comprising the at least one additional device to the second apparatus for localizing the first apparatus.

In some example embodiments, the location information status is indicated by an indicator, a first value of the indicator indicates the location information status is valid, and a second different value of the indicator indicates the location information status is invalid.

In some example embodiments, the reference information about the additional device to be discovered comprises at least one of the following: a first indicator of a device to be excluded from the additional device to be discovered, or a second indicator of a device to be included as the additional device to be discovered.

In some example embodiments, the third apparatus further comprises: means for receiving, from the second apparatus, an indication of updating the location information status to be valid.

In some example embodiments, the third apparatus acts as a server terminal device, and wherein the third apparatus further comprises: means for determining, based on a plurality of sidelink positioning reference signals during the sidelink positioning, a location of the third apparatus; and means for updating the location information status of the third apparatus from invalid to valid.

In some example embodiments, the at least one additional device comprises at least one network device or at least one terminal device with valid location status.

In some example embodiments, the first apparatus is a first terminal device, the second apparatus is a network device implementing a location management function, and the third apparatus is a second terminal device.

In some example embodiments, the third apparatus further comprises means for performing other operations in some example embodiments of the method 700 or the third apparatus 130. In some example embodiments, the means comprises at least one processor; and at least one memory storing instructions that, when executed by the at least one processor, cause the performance of the third apparatus.

In some example embodiments, a fourth apparatus capable of performing any of the method 800 (for example, the fourth apparatus 310 in FIG. 4 may comprise means for performing the respective operations of the method 800. The means may be implemented in any suitable form. For example, the means may be implemented in a circuitry or software module. The fourth apparatus may be implemented as or included in the fourth apparatus 310 in FIG. 4.

In some example embodiments, the fourth apparatus comprises means for obtaining at least one location information status of at least one candidate device via sidelink communication; means for determining, from the at least one candidate device, a plurality of terminal devices for localizing the fourth apparatus, at least one of the plurality of terminal devices being with invalid location information status; means for transmitting, to the at least one terminal device with the invalid location information status, an indication of additional device discovery with reference information about an additional device to be discovered; means for receiving, from the at least one terminal device with the invalid location information status, an additional device list comprising at least one additional device conforming the reference information; and localizing, with an assistance of at least a part of the terminal devices with valid location information statuses and the at least one additional device, the fourth apparatus.

In some example embodiments, the location information status is indicated by an indicator, a first value of the indicator indicates the location information status of the corresponding candidate device is valid, and a second different value of the indicator indicates the location information status of the corresponding candidate device is invalid.

In some example embodiments, the localizing is initiated by the fourth apparatus, and the fourth apparatus comprises a terminal device.

In some example embodiments, the reference information about the additional device to be discovered comprises at least one of the following: a first indicator of a device to be excluded from the additional device to be discovered, or a second indicator of a device to be included as the additional device to be discovered.

In some example embodiments, the device to be excluded from the at least one additional device comprises the fourth apparatus and the plurality of terminal devices.

In some example embodiments, the fourth apparatus further comprises: means for determining, based on a plurality of sidelink positioning reference signals during the sidelink positioning, a location of the fourth apparatus and a location of the at least one terminal device.

In some example embodiments, the location of the fourth apparatus and the location of the at least one terminal device are determined based on observed time difference of arrival or round-trip time associated with the plurality of sidelink positioning reference signals.

In some example embodiments, the fourth apparatus further comprises: means for transmitting, to the at least one terminal device with the invalid location information status, an indication of updating the location information status to be valid.

In some example embodiments, the fourth apparatus further comprises means for performing other operations in some example embodiments of the method 800 or the fourth apparatus 310. In some example embodiments, the means comprises at least one processor; and at least one memory storing instructions that, when executed by the at least one processor, cause the performance of the fourth apparatus.

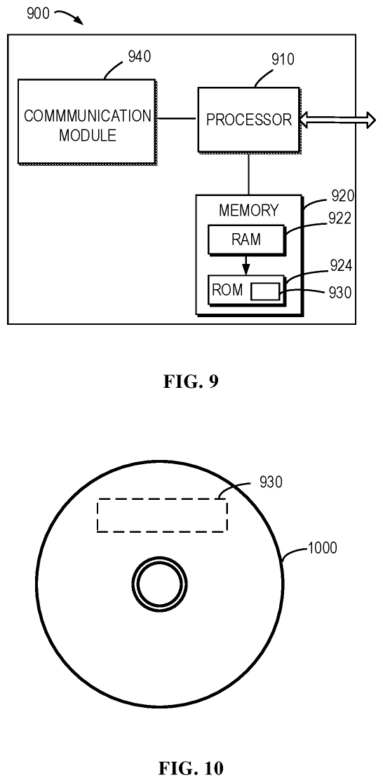

FIG. 9 is a simplified block diagram of a device 900 that is suitable for implementing example embodiments of the present disclosure. The device 900 may be provided to implement a communication device, for example, the first apparatus 110, the second apparatus 120, the third apparatus 130 as shown in FIG. 1 or the fourth apparatus 310 as shown in FIG. 4. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924.

The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 2 to FIG. 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus at least to:
transmit a discovery request for device discovery via sidelink communication;
receive, from at least one candidate device, at least one respective discovery response comprising a location information status of a corresponding one of the at least one candidate device; and
transmit a candidate device list with the location information status to a second apparatus for localizing the first apparatus.

2. The first apparatus of claim 1, wherein the location information status is indicated by an indicator, a first value of the indicator indicates the location information status of the corresponding candidate device is valid, and a second different value of the indicator indicates the location information status of the corresponding candidate device is invalid.

3. The first apparatus of claim 1, wherein the localizing is initiated by the second apparatus, and the second apparatus comprises a network device implementing location management function.

4. A third apparatus comprising:
at least one processor; and
at least one memory storing instructions that, when executed by the at least one processor, cause the third apparatus at least to:
receive, from a first apparatus, a discovery request for device discovery via sidelink communication;
transmit, to the first apparatus, a discovery response comprising an invalid location information status of the third apparatus;
upon receipt of an indication of additional device discovery from a second apparatus for location management, perform the additional device discovery, the indication comprising reference information about an additional device to be discovered;
determine at least one additional device conforming the reference information; and
transmit an additional device list comprising the at least one additional device to the second apparatus for localizing the first apparatus.

5. The third apparatus of claim 4, wherein the location information status is indicated by an indicator, a first value of the indicator indicates the location information status is valid, and a second different value of the indicator indicates the location information status is invalid.

6. The third apparatus of claim 4, wherein the reference information about the additional device to be discovered comprises at least one of the following:
a first indicator of a device to be excluded from the additional device to be discovered, or
a second indicator of a device to be included as the additional device to be discovered.

7. The third apparatus of claim 4, wherein the third apparatus is further caused to:
receive, from the second apparatus, an indication of updating the location information status to be valid.

8. The third apparatus of claim 4, wherein the third apparatus acts as a server terminal device, and wherein the third apparatus is further caused to:
determine, based on a plurality of sidelink positioning reference signals during the sidelink positioning, a location of the third apparatus; and
update the location information status of the third apparatus from invalid to valid.

9. The third apparatus of claim 4, wherein the at least one additional device comprises at least one network device or at least one terminal device with valid location status.

10. The third apparatus of claim 4, wherein the first apparatus is a first terminal device, the second apparatus is a network device implementing a location management function, and the third apparatus is a second terminal device.

11. A fourth apparatus comprising:
at least one processor; and
at least one memory storing instructions that, when executed by the at least one processor, cause the fourth apparatus at least to:
obtain at least one location information status of at least one candidate device via sidelink communication;
determine, from the at least one candidate device, a plurality of terminal devices for localizing the fourth apparatus, at least one of the plurality of terminal devices being with invalid location information status;
transmit, to the at least one terminal device with the invalid location information status, an indication of additional device discovery with reference information about an additional device to be discovered;
receive, from the at least one terminal device with the invalid location information status, an additional device list comprising at least one additional device conforming the reference information; and
localize, with an assistance of at least a part of the terminal devices with valid location information statuses and the at least one additional device, the fourth apparatus.

12. The fourth apparatus of claim 11, wherein the location information status is indicated by an indicator, a first value of the indicator indicates the location information status of the corresponding candidate device is valid, and a second different value of the indicator indicates the location information status of the corresponding candidate device is invalid.

13. The fourth apparatus of claim 11, wherein the localizing is initiated by the fourth apparatus, and the fourth apparatus comprises a terminal device.

14. The fourth apparatus of claim 11, wherein the reference information about the additional device to be discovered comprises at least one of the following:
a first indicator of a device to be excluded from the additional device to be discovered, or
a second indicator of a device to be included as the additional device to be discovered.

15. The fourth apparatus 14, wherein the device to be excluded from the at least one additional device comprises the fourth apparatus and the plurality of terminal devices.

16. The fourth apparatus of claim 11, wherein the fourth device is further caused to:
determine, based on a plurality of sidelink positioning reference signals during the sidelink positioning, a location of the fourth apparatus and a location of the at least one terminal device.

17. The fourth apparatus of claim 16, wherein the location of the fourth apparatus and the location of the at least one terminal device are determined based on observed time difference of arrival or round trip time associated with the plurality of sidelink positioning reference signals.

18. The fourth apparatus of claim 11, wherein the fourth device is further caused to:
transmit, to the at least one terminal device with the invalid location information status, an indication of updating the location information status to be valid.
